(19) United States
(12) Patent Application Publication
(10) Pub. No.: US 2007/0002949 A1
(43) Pub. Date: Jan. 4, 2007

(54) Fast partial pixel motion estimation for video encoding

(75) Inventors: Ngai-Man Cheung, Irving, TX (US); Yiliang Bao, Irving, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/173,293

(22) Filed: Jun. 30, 2005

(51) Int. Cl. H04N 11/02

(52) U.S. Cl. 375/240.16

(57) ABSTRACT

Fast partial pixel motion estimation for video encoding can include a technique in which a current partition mode is determined. Where the current partition mode is a 16 by 16 mode, an estimation module compares the gain from a half-pel motion estimation against a half-pel gain threshold and, if the gain exceeds the half-pel gain threshold, the estimation module performs a quarter-pel motion estimation for an entire partition. Where the current partition mode is a 16 by 8 or a 8 by 16 mode, the estimation module determines if a current partition is the first partition in the current macroblock. If the current partition is the first partition in the current macroblock, the estimation module performs a quarter-pel motion estimation for the current partition, determines if the gain from quarter-pel motion estimation is greater than a quarter-pel gain threshold, and sets a flag to true if the gain from quarter-pel motion estimation is greater and the flag to false if the gain from quarter-pel motion estimation is not greater. If the current partition is not the first partition in the current macroblock, the estimation module determines if the flag is true or false and, if true, estimation module performs a quarter-pel motion estimation for the current partition.

### CROSS REFERENCE TO RELATED APPLICATIONS

None.

### BACKGROUND OF THE INVENTION

1. Field of the Invention

The present invention relates generally to video encoding methods and systems. More specifically, the present invention relates to techniques for motion estimation in video encoding.

2. Description of the Related Art

This section is intended to provide a background or context. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

The H.264/MPEG-4 AVC video coding standard has improved compression performance and network friendliness compared with previous video coding algorithms. The H.264 standard testing and development model, known as Joint Model (JM), typically achieves the same quality of compressed video as MPEG-4 with half the bit-rate. Moreover, the H.264 standard performs very well for a wide range of bit-rates and resolutions.

Efforts have been made to implement the H.264 standard in wireless products for applications like video conferencing and video streaming. Reference encoders have been developed on embedded platforms for future products. However, one challenge of developing a video encoder in an embedded environment is computational resource. Embedded platforms typically employ low-cost, low-power digital signal processors (DSPs) running at relatively low CPU clock frequency. On the other hand, video encoding requires huge amount of computational cycles and needs to meet a very stringent real-time requirement. Accordingly, video encoding in embedded environments requires improved algorithms.

In general, video encoding uses motion estimation and motion compensation to remove temporal redundancy. Usually an M×N block of the current frame is matched against all the M×N blocks within the search region of the reference frame (which can be past or future frames in display order). The matching criterion is to minimize a cost that can be comprised of both distortion measurement and the number of bits required to encode the motion vectors (MV) and syntax overhead.

Motion estimation is computationally expensive. However, new video standards like the H.264 standard have added new computationally expensive tools to improve estimation accuracy. In particular, the H.264 standard includes tree structured motion estimation/compensation and motion vector is of quarter-pel resolution. As a person of skill would appreciate, each line of a video frame is defined by a sequence of digital data bits, or pixels (also referred to as “pels”).

In tree structured motion estimation and motion compensation, a macroblock could be divided into one 16×16 partition, or two 8×16 partitions, or two 16×8 partitions or four 8×8 partitions. If the macroblock is divided into four 8×8 partitions, each 8×8 partition is referred to as one sub-macroblock (sub-MB) and each sub-MB may be further split in 4 different ways, either as one 8×8, or two 8×4, or two 4×8 or four 4×4 sub-MB partitions.

The motion estimation process needs to find an optimal way to partition the macroblock as well as the best motion vector for each partition or sub-macroblock partition. There is an independent motion vector associated with each partition or sub-MB partition. When a motion estimation process searches for the best motion vector, it needs to examine integer-pel, half-pel and quarter-pel search positions.

There is a need for a low complexity quarter-pel motion estimation process to ease computational cycles requirements. Further, there is a need for an estimation module that reduces the complexity requirement of video encoding and, thus, facilitates the development of video products and applications. Even still further, there is a need for partial pixel motion estimation for video encoding, especially for wireless implementations.

### SUMMARY OF THE INVENTION

In general, the present invention relates to a quarter-pel motion estimation method. The method utilizes the results from a half-pel motion estimation to reduce the number of quarter-pel motion estimations performed while achieving an acceptable result by performing key quarter-pel motion estimations. Exemplary embodiments utilize a heuristic that if a half-pel motion estimation does not result in much gain (and, thus, much decrease in cost), then the quarter-pel motion estimation for that half-pel will not result in much gain either. Another heuristic utilized is that if the first 16×8 or 8×16 mode quarter-pel motion estimation does not result in much gain, then the subsequent 16×8 or 8×16 quarter-pel motion estimation will not have much gain either.

One exemplary embodiment relates to a method of motion estimation in video encoding. The method includes determining a current mode. Where the current mode is a 16 by 16 mode, the method compares the gain of a half-pel motion estimation against a half-pel gain threshold and, if the gain exceeds the half-pel gain threshold, performs a quarter-pel motion estimation for an entire partition. Here the gain of half-pel motion estimation refers to the reduction in the cost measure that can be comprised of both distortion measurement and the number of bits required to encode the motion vectors (MV) and syntax overhead, compared to the scenario where no half-pel motion estimation is performed. Where the current mode is a 16 by 8 or a 8 by 16 mode, the method determines if a current partition is the first partition in the macroblock. If the current partition is the first partition in the macroblock, the method performs a quarter-pel motion estimation for the current partition, determines if a gain from quarter-pel motion estimation is greater than a quarter-pel gain threshold, and sets a flag to true if the gain from quarter-pel motion estimation is greater and the flag to false if the gain from quarter-pel motion estimation is not greater. If the current partition is not the first partition in the macroblock, the method determines if the flag is true or false and, if true, the method performs a quarter-pel motion estimation for the current partition. Here the gain of quarter-pel motion estimation refers to the reduction in the cost measure that can be comprised of both distortion measurement and the number of bits required to encode the motion vectors (MV) and syntax overhead, compared to the scenario where no quarter-pel motion estimation is performed.

Another exemplary embodiment relates to an encoder for performing motion compensated encoding of video information. The encoder can include means for determining a current partition mode, means for comparing gain from a half-pel motion estimation against a half-pel gain threshold where the current partition mode is determined to be a 16 by 16 mode and performing a quarter-pel motion estimation for an entire partition if the gain exceeds the half-pel gain threshold, and means for determining if a current partition is the first partition in the macroblock where the current partition mode is determined to be 16 by 8 or 8 by 16. The encoder further can include means for performing a quarter-pel motion estimation for the current partition, determining if the gain from quarter-pel motion estimation is greater than a quarter-pel gain threshold, and setting a flag to true if the gain from quarter-pel motion estimationis greater and the flag to false if the gain from quarter-pel motion estimation is not greater, if the current partition is the first partition in the macroblock; and means for determining if the flag is true or false and means for performing a quarter-pel motion estimation for the current partition if the current partition is not the first partition in the macroblock and the flag is determined to be true.

Another exemplary embodiment relates to an estimation module that reduces the complexity requirement of video encoding. The module can include a mode identifier that determines a current partition mode, a comparator that compares the gain from quarter-pel motion estimation with a quarter-pel gain threshold and the gain from half-pel motion estimation with a half-pel gain threshold, and a processing unit. The processing unit performs quarter-pel motion estimations when the gain from the half-pel motion estimation is greater that the half-pel gain threshold in a 16 by 16 mode, when a current partition is first in a current macroblock and in a 16 by 8 or 8 by 16 mode, and when the gain from quarter-pel motion estimation is greater than the quarter-pel gain threshold and the current partition is not first in the current macroblock and in the 16 by 8 or 8 by 16 mode.

Another exemplary embodiment relates to a computer program product utilized in video encoding. The computer program product can include computer code to determine a partition mode and computer code that performs quarter-pel motion estimations when a gain from half-pel motion estimation is greater that a half-pel gain threshold in a 16 by 16 mode, when a current partition is the first in a current macroblock and in a 16 by 8 or 8 by 16 mode, and when the gain from quarter-pel motion estimation is greater than the quarter-pel gain threshold and the current partition is not the first in the current macroblock and in the 16 by 8 or 8 by 16 mode.

### BRIEF DESCRIPTION OF DRAWINGS

FIG. 1 is a graph depicting rate-distortion (RD) performance of an encoder with and without an exemplary quarter-pel motion estimation algorithm.

FIG. 2 is a diagram of a quarter-pel motion estimation algorithm in accordance with an exemplary embodiment.

FIG. 3 is a graph depicting RD performance of a conventional encoder and an encoder modified with a quarter-pel motion estimation algorithm in accordance with an exemplary embodiment.

FIG. 4 is a graph depicting RD performance of a conventional encoder and an encoder modified with a quarter-pel motion estimation algorithm in accordance with an exemplary embodiment.

FIG. 5 is a graph depicting RD performance of a conventional encoder and an encoder modified with a quarter-pel motion estimation algorithm in accordance with an exemplary embodiment.

FIG. 6 is a graph depicting RD performance of a conventional encoder and an encoder modified with a quarter-pel motion estimation algorithm in accordance with an exemplary embodiment.

FIG. 7 is a general diagram depicting a mobile station in accordance with an exemplary embodiment.

FIG. 8 is a schematic of a mobile telecommunication network comprising a network element in accordance with an exemplary embodiment.

FIG. 9 is a perspective view of a device that can be used in the implementation of the present invention.

FIG. 10 is a schematic representation of the telephone circuitry of the mobile telephone of FIG. 9.

### DETAILED DESCRIPTION OF EXEMPLARY EMBODIMENTS

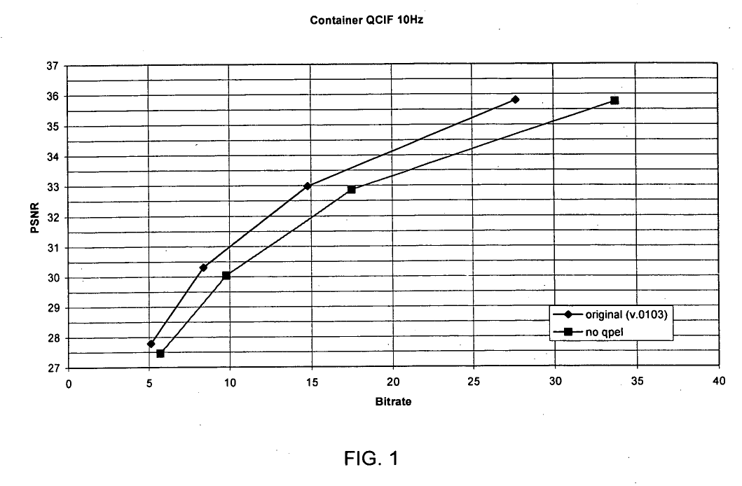

FIG. 1 illustrates a graph depicting rate-distortion (RD) performance of an encoder with and without a quarter-pel motion estimation. The graphs are measured in average bit rates and average PSNR for each test sequence. PSNR refers to the peak signal-to-noise ratio of the reconstructed image. The PSNR of each image in a video sequence can be determined from the mean squared error (MSE) of a reconstructed image according to the equation:
MSE=(Σ[f(i,j)−F(i,j)]²)/(M*N)
where f(i,j) is a source image containing M by N pixels and F(i,j) is a reconstructed image where F is reconstructed by decoding the encoded version of f(i,j). The summation is over all pixels. PSNR of a reconstructed image in decibels (dB) is computed by using the equation:
PSNR=20 log₁₀(255/RMSE)
where the root mean squared error (RMSE) is the square root of MSE. The average PSNR of reconstructed video is typically in the range between 20 and 40. The actual value of PSNR is an indication of the quality of the reconstructed video , but the comparison between two values for different reconstructed videos gives the improvement of the coding efficiency achieved by one algorithm compared to the other.

As illustrated in FIG. 1, skipping quarter-pel motion estimation entirely is not an option as that would incur much quality loss. The lines on the graph of FIG. 1 illustrate that skipping quarter-pel may incur as much as a 1 dB quality loss. If quarter-pel is skipped judiciously, as described below, it is possible to limit quality loss to 0.1 dB.

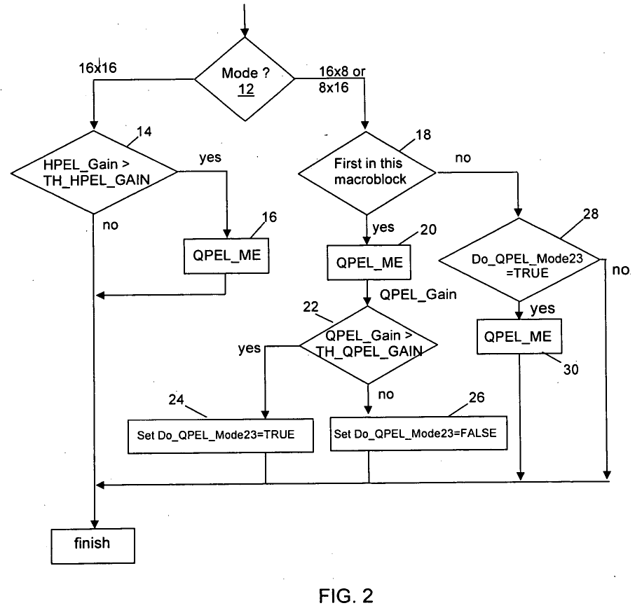

FIG. 2 illustrates operations performed in a quarter-pel motion estimation algorithm. Heuristics H1 and H2 are utilized in the quarter-pel motion estimation algorithm. Heuristic H1 refers to the following: if half-pel motion estimation does not result in much gain (decrease in cost), then so will be the quarter-pel motion estimation. Since quarter-pel motion estimation of a partition is always preceded by half-pel motion estimation, it is cost-beneficial if half-pel motion estimation result could help determine if the subsequent quarter-pel motion estimation could result in much gain or not. Both half and quarter-pel motion estimation are operating on the pixel samples of the same partition, except that quarter-pel motion estimation searches on positions in the reference frame with higher spatial precision. Heuristic H2 refers to the following: if the first 16×8 or 8×16 mode quarter-pel motion estimation does not result in much gain then so will be the quarter-pel motion estimation for the second 16×8 or 8×16 partition in the macroblock.

The following operations are performed during an exemplary motion estimation process, including heuristics H1 and H2. Additional, fewer, or different operations may be performed depending on the embodiment or implementation of the algorithm. In an operation 12, a determination is made whether the current partition is 16×16 or 16×8/8×16. If the current mode is 16×16, gain from half-pel motion estimation, (HPEL_Gain), is tested against a half-pel gain threshold (TH_HPEL_GAIN) in an operation 14. HPEL_Gain can be measured as the reduction in cost by using the best half-pel MV rather than the integer-pel MV.

If HPEL_Gain is greater than TH_HPEL_GAIN, then a quarter-pel motion estimation (QPEL_ME) is performed for an entire partition in an operation 16. According to the above conditions, the expected gain by performing QPEL_ME should be large and, thus, the computation is justified. If HPEL_Gain is smaller or equal to TH_HPEL_GAIN, the expected gain by performing QPEL_ME should be too small to justify the computation, the QPEL_ME is skipped.

If the current mode being examined is either 16×8 or 8×16, an operation 18 is performed to determine if the partition is the first in a macroblock. If it is the first, QPEL_ME is performed for the first 16×8 or 8×16 partition in the macroblock (operation 20). QPEL_ME returns the best motion vector along with the updated cost. In an operation 22, the gain of QPEL_ME (decrease in cost), QPEL_Gain, is compared against TH_QPEL_GAIN. If QPEL_Gain is greater than TH_QPEL_GAIN, then Do_QPEL_Mode23 is set to TRUE in an operation 24 to enable QPEL_ME of the subsequent partition in the same macroblock. If QPEL_Gain is less than or equal to TH_QPEL_GAIN then Do_QPEL_Mode23 is set to FALSE in an operation 26 to skip the QPEL_ME of the second partition in the same macroblock. If the partition is not the first partition of the macroblock, a check is made in an operation 28 whether Do_QPEL Mode23 is TRUE. If the condition is met, an operation 30 is performed in which the quarter-pel motion estimation (QPEL_ME) is performed.

While the description is provided only for reducing the complexity of 16×16, 16×8 and 8×16 modes, it is possible to extend the method to search quarter-pel locations for partition or sub-MB partition of other sizes. The thresholds TH_HPEL_GAIN and TH_QPEL_GAIN can be statically determined before the encoding, or dynamically updated during the encoding by considering the HPEL_Gain and QPEL_Gain of neighboring macroblocks. In alternative embodiments, both heuristics H1 and H2 can be disabled in some macroblocks to determine the degradation that would have caused by using the current TH_HPEL_GAIN and TH_QPEL_GAIN settings, and adjust the thresholds accordingly.

While the description is provided only for reducing the quarter-pixel motion estimation, it is possible to extend the method to motion estimation of motion vector of higher precision, for example, ⅛ pel.

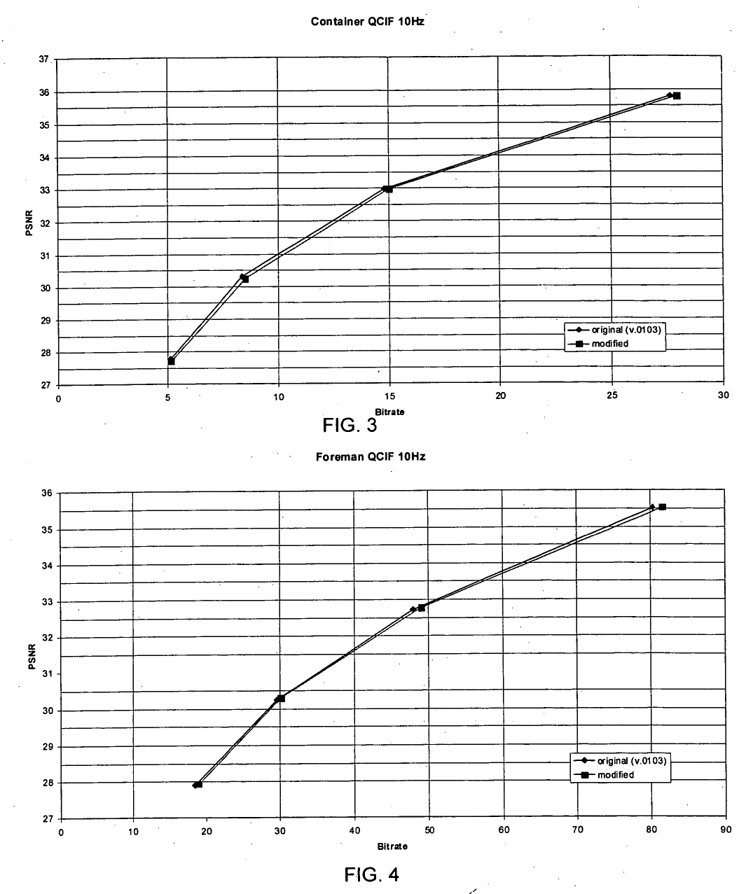

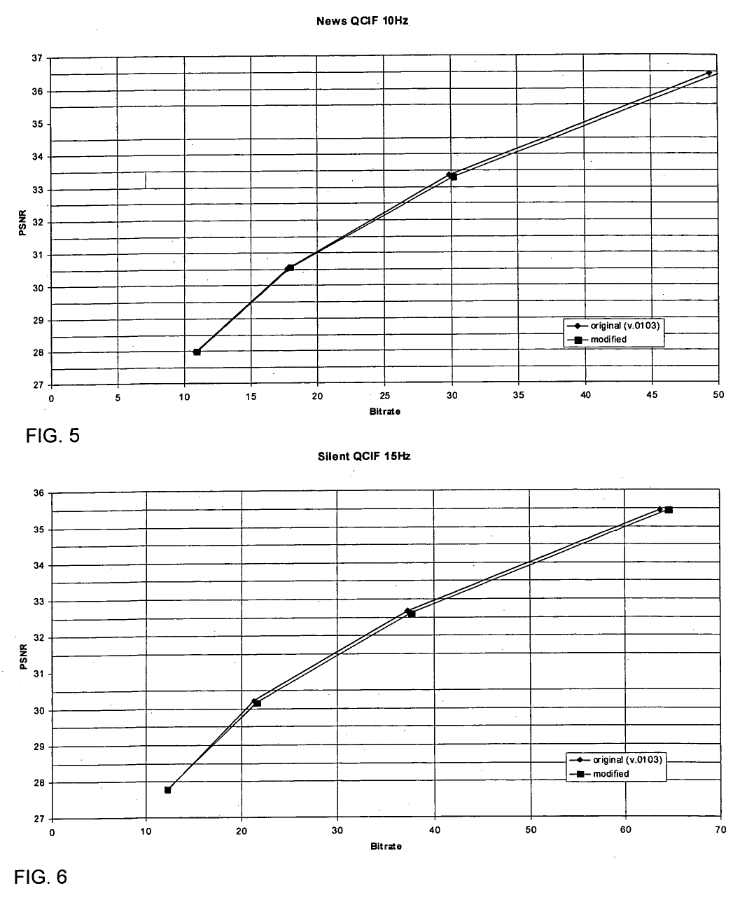

FIGS. 3-6 illustrate graphs depicting rate-distortion (RD) performance of a conventional encoder and an encoder modified with a quarter-pel motion estimation algorithm using four video sequences “Container”, “Foreman”, “News” and “Silence”. The graphs compare the rate-distortion performance and the results. As shown in the Figures, the quality loss is at most 0.1 dB using the low complexity quarter-pel motion estimation.

Table 1 below shows execution time reduction using an exemplary quarter-pel motion estimation (QPEL ME) algorithm described as described with reference to the Figures. As shown in the table, the proposed algorithm can reduce the QPEL ME by 53% compared with a conventional encoder on average.

TABLE 1

| % reduction | | |
|---|---|---|
| in QPEL ME | % reduction in ME | % reduction in encoding speed |
| 53.51 | 14.75 | 7.122 |

A variety of different implementations can utilize the quarter-pel motion estimation (QPEL ME) algorithm. For example, the algorithm is suitable to be deployed in a video encoder running in an embedded environment using DSP/ARM, since the algorithm can reduce QPEL ME complexity at a negligible quality degradation. Other implementations are also possible.

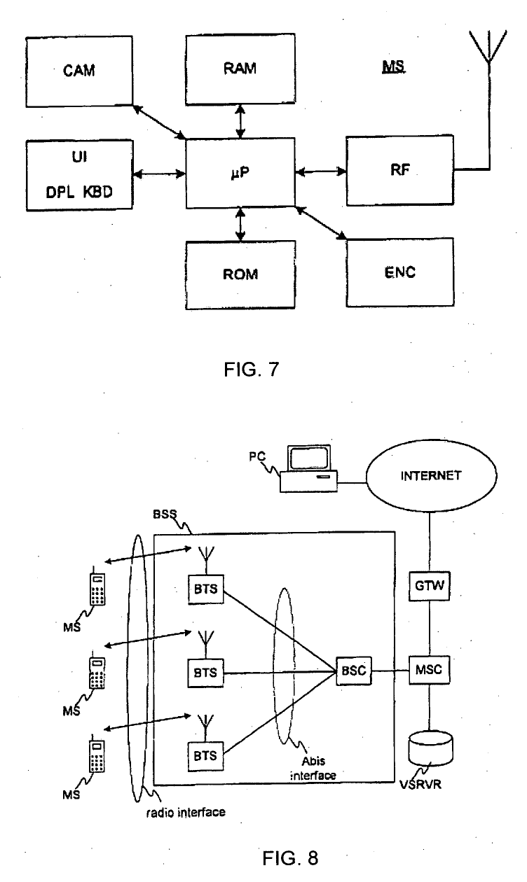

FIG. 7 illustrates a mobile station MS according to an exemplary embodiment. A central processing unit, microprocessor μP controls the blocks responsible for different functions of the mobile station: a random access memory RAM, a radio frequency block RF, a read only memory ROM, a user interface UI having a display DPL and a keyboard KBD, and a digital camera block CAM. The microprocessor's operating instructions, that is program code and the mobile station's basic functions have been stored in the mobile station in advance, for example during the manufacturing process, in the ROM. In accordance with its program, the microprocessor uses the RF block for transmitting and receiving messages on a radio path. The microprocessor monitors the state of the user interface UI and controls the digital camera block CAM.

In response to a user command, the microprocessor instructs the camera block CAM to record a digital image into the RAM. Once the image is captured or alternatively during the capturing process, the microprocessor segments the image into image segments and performs motion compensated encoding for the segments. The exemplary motion estimation algorithm described with reference to FIGS. 1-6 is utilized.

A user may command the mobile station to display the image on its display or to send the compressed image using the RF block to another mobile station, a wired telephone or another telecommunications device. In a preferred embodiment, such transmission of image data is started as soon as the first segment is encoded so that the recipient can start a corresponding decoding process with a minimum delay. In an alternative embodiment, the mobile station comprises an encoder block ENC dedicated for encoding and possibly also for decoding of digital video data.

FIG. 8 illustrates a schematic diagram of a mobile telecommunications network according to an exemplary embodiment. Mobile stations MS are in communication with base stations BTS by means of a radio link. The base stations BTS are further connected, through an Abis interface, to a base station controller BSC, which controls and manages several base stations. The entity formed by a number of base stations BTS and a single base station controller BSC, controlling the base stations, is called a base station subsystem BSS. The base station controller BSC manages radio communication channels and handovers. On the other hand, the base station controller BSC is connected, through an A interface, to a mobile services switching centre MSC, which co-ordinates the formation of connections to and from mobile stations. A further connection is made, through the mobile service switching centre MSC, to outside the mobile communications network.

Outside the mobile communications network there may further reside other network(s) connected to the mobile communications network by gateway(s) GTW, for example the Internet or a Public Switched Telephone Network (PSTN). In such an external network, or in the telecommunications network, there may be located another video decoding or encoding stations, such as computers PC. In an exemplary embodiment of, the mobile telecommunications network comprises a video server VSRVR to provide video data to a MS subscribing to such a service. The video server may function as a gateway to an online video source or it may comprise previously recorded video clips. Videotelephony applications may involve, for example, two mobile stations or one mobile station MS and a videotelephone connected to the PSTN, a PC connected to the Internet or a H.264 compatible terminal connected either to the Internet or to the PSTN.

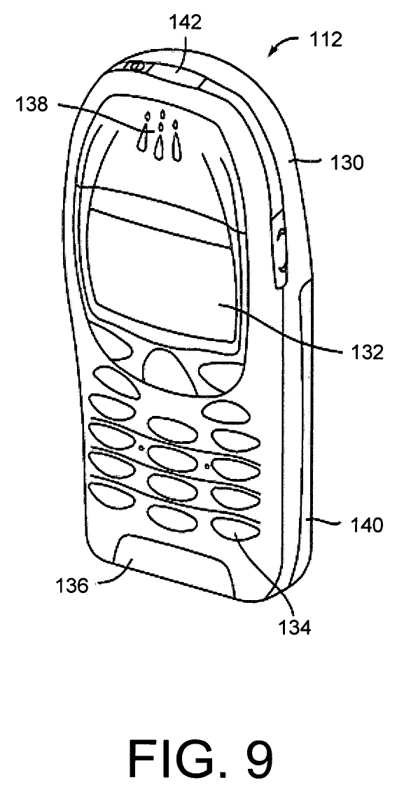

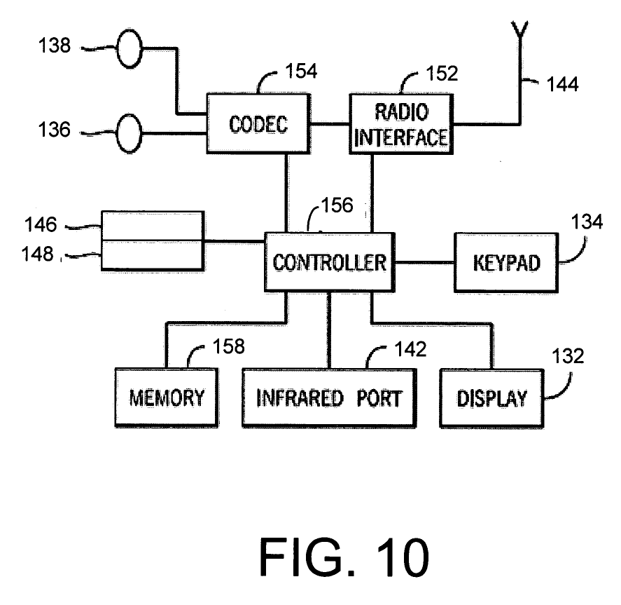

FIGS. 9 and 10 show one representative device 112 within which the present invention may be implemented. The device 112 of FIGS. 9 and 10 comprises a mobile telephone. It should be understood, however, that the present invention is not intended to be limited to one particular type of mobile telephone or other electronic device. In particular, it should be noted that the present invention is applicable to any device that performs quarter-pel motion estimation using encoding. In fact, the present invention may even be utilized in transcoding within a server. The device 112 of FIGS. 9 and 10 includes a housing 130, a display 132 in the form of a liquid crystal display, a keypad 134, a microphone 136, an ear-piece 138, a battery 140, an infrared port 142, an antenna 144, a smart card 146 in the form of a UICC according to one embodiment of the invention, a card reader 148, radio interface circuitry 52, codec circuitry 154, a controller 156 and a memory 158. Individual circuits and elements are all of a type well known in the art, for example in the Nokia range of mobile telephones.

While several embodiments of the invention have been described, it is to be understood that modifications and changes will occur to those skilled in the art to which the invention pertains. Accordingly, the claims appended to this specification are intended to define the invention precisely.

1. A method of motion estimation in video encoding, the method comprising:
determining a current mode;
where the current mode is a first mode, comparing gain from a half-pel motion estimation against a half-pel gain threshold and performing a quarter-pel motion estimation for an entire partition if the gain exceeds the half-pel gain threshold; and
where the current mode is a second mode,
determining if a current partition is the first partition in the macroblock;
if the current partition is the first partition in the macroblock, performing a quarter-pel motion estimation for the current partition, determining if a gain from quarter-pel motion estimation is greater than a quarter-pel gain threshold, and setting a flag to true if the quarter-pel gain is greater and the flag to false if the quarter-pel gain is not greater; and
if the current partition is not the first partition in the macroblock, determining if the flag is true or false and, if true, performing a quarter-pel motion estimation for the current partition.

2. The method of claim 1, wherein the first mode is 16 by 16.

3. The method of claim 1, wherein the second mode is 16 by 8 or 8 by 16.

4. The method of claim 1, wherein the quarter-pel gain threshold is adjusted based on degradation caused by current threshold levels.

5. The method of claim 1, wherein the half-pel gain threshold is adjusted based on degradation caused by current threshold levels.

6. An encoder for performing motion compensated encoding of video information, the encoder comprising:
means for determining a current partition mode;
means for comparing gain from a half-pel motion estimation against a half-pel gain threshold where the current partition mode is determined to be a 16 by 16 mode and performing a quarter-pel motion estimation for an entire partition if the gain exceeds the half-pel gain threshold;
means for determining if a current partition is the first partition in the macroblock where the current partition mode is determined to be 16 by 8 or 8 by 16;
means for performing a quarter-pel motion estimation for the current partition, determining if a gain from the quarter-pel motion estimation is greater than a quarter-pel threshold, and setting a flag to true if the gain from quarter-pel motion estimation is greater and the flag to false if the gain from quarter-pel motion estimation is not greater, if the current partition is the first partition in the macroblock; and
means for determining if the flag is true or false and means for performing a quarter-pel motion estimation for the current partition if the current partition is not the first partition in the macroblock and the flag is determined to be true.

7. The encoder of claim 6, further comprising means for adjusting the quarter-pel gain threshold based on degradation caused by current threshold levels.

8. The encoder of claim 6, further comprising means for adjusting the half-pel gain threshold based on degradation caused by current threshold levels.

9. The encoder of claim 6, wherein the quarter-pel gain threshold and the half-pel gain threshold are determined statically before encoding.

10. The encoder of claim 6, wherein the quarter-pel gain threshold and the half-pel gain threshold are dynamically updated during encoding by considering the gains from quarter-pel and half-pel motion estimation of neighboring macroblocks.

11. An estimation module that reduces the complexity requirement of video encoding, the module comprising:
a mode identifier that determines a current partition mode;
a comparator that compares gain from quarter-pel motion estimation with a quarter-pel gain threshold and the gain from half-pel motion estimation with a half-pel gain threshold;
a processing unit that performs quarter-pel motion estimations when the the gain from half-pel motion estimation is greater than the half-pel gain threshold in a 16 by 16 mode, when a current partition is the first partition in the current macroblock and in a 16 by 8 or 8 by 16 mode, and when the gain from quarter-pel motion estimation is greater than the quarter-pel gain threshold and the current partition is not the first in the current macroblock and in the 16 by 8 or 8 by 16 mode.

12. The module of claim 11, wherein the processing unit adjusts the quarter-pel gain threshold based on degradation caused by current threshold levels.

13. The module of claim 11, wherein the processing unit adjusts the half-pel gain threshold based on degradation caused by current threshold levels.

14. The module of claim 11, wherein the quarter-pel gain threshold and the half-pel gain threshold are determined statically before encoding.

15. The module of claim 1 1, wherein the quarter-pel gain threshold and the half-pel gain threshold are dynamically updated during encoding by considering the gains from quarter-pel and half-pel motion estimation of neighboring macroblocks.

16. A computer program product utilized in video encoding comprising:
computer code to determine a partition mode; and
computer code that performs quarter-pel motion estimations when a gain from half-pel motion estimation is greater than a half-pel gain threshold in a 16 by 16 mode, when a current partition is the first partition in the current macroblock and in a 16 by 8 or 8 by 16 mode, and when the gain from quarter-pel motion estimation is greater than the quarter-pel gain threshold and the current partition is not the first partition in the current macroblock and in the 16 by 8 or 8 by 16 mode.

17. The computer program product of claim 16, wherein the computer code that performs quarter-pel motion estimations adjusts the quarter-pel gain threshold based on degradation caused by current threshold levels.

18. The computer program product of claim 16, wherein the computer code that performs quarter-pel motion estimations adjusts the half-pel gain threshold based on degradation caused by current threshold levels.

19. The computer program product of claim 16, wherein the quarter-pel gain threshold and the half-pel gain threshold are determined statically before encoding.

20. The computer program product of claim 16, wherein the quarter-pel gain threshold and the half-pel gain threshold are dynamically updated during encoding by considering the gains from quarter-pel and half-pel motion estimation of neighboring macroblocks.
